(19) United States
(12) Patent Application Publication
(10) Pub. No.: US 2026/0313614 A1
(43) Pub. Date: Oct. 8, 2026

(54) SENSING-BASED CLOCK SYNCHRONIZATION

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US); Yiwu TANG, San Diego, CA (US); Yue CHAO, San Diego, CA (US)

(21) Appl. No.: 19/169,751

(22) Filed: Apr. 3, 2025

(51) Int. Cl. H04W 72/02; H04B 17/309; H04J 3/06; H04W 72/541

(52) U.S. Cl. CPC H04W 72/02; H04B 17/346; H04J 3/0658; H04W 72/541

(57) ABSTRACT

In some aspects, a reader device may sense a channel. The reader device may measure interference on one or more subchannels of the channel. The reader device may select a subchannel, of the one or more subchannels, that satisfies an interference threshold. The reader device may transmit a clock synchronization signal or a preamble on the selected subchannel. Numerous other aspects are described.

### FIELD OF THE DISCLOSURE

Aspects of the present disclosure generally relate to wireless communication and, for example, sensing-based clock synchronization for devices.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network (e.g., a wireless local area network (WLAN), such as a Wi-Fi (for example, Institute of Electrical and Electronics Engineers (IEEE) 802.11) network) may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a station may communicate with an associated AP via downlink and uplink. “Downlink” may refer to the communication link from the AP to the station, and “uplink” may refer to the communication link from the station to the AP.

The AP may be coupled to a network, such as the Internet, and may enable a mobile device to communicate via the network (or communicate with other devices coupled to the AP). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to a method of wireless communication performed by a reader device. The method may include sensing a channel. The method may include measuring interference on one or more subchannels of the channel. The method may include selecting a subchannel, of the one or more subchannels, that satisfies an interference threshold. The method may include transmitting a clock synchronization signal or a preamble on the selected subchannel.

Some aspects described herein relate to a method of wireless communication performed by a wireless device. The method may include selecting a subchannel, of a channel associated with a reader device, that corresponds to a quantity of clock cycles. The method may include receiving a clock synchronization signal or a preamble on the selected subchannel.

Some aspects described herein relate to a reader device. The reader device may include a processing system. The processing system may include one or more processors and one or more code-storing memories coupled with the one or more processors. The processing system may be configured to cause the reader device to sense a channel. The processing system may be configured to cause the reader device to measure interference on one or more subchannels of the channel. The processing system may be configured to cause the reader device to select a subchannel, of the one or more subchannels, that satisfies an interference threshold. The processing system may be configured to cause the reader device to transmit a clock synchronization signal or a preamble on the selected subchannel.

Some aspects described herein relate to a wireless device. The wireless device may include a processing system. The processing system may include one or more processors and one or more code-storing memories coupled with the one or more processors. The processing system may be configured to cause the wireless device to select a subchannel, of a channel associated with a reader device, that corresponds to a quantity of clock cycles. The processing system may be configured to cause the wireless device to receive a clock synchronization signal or a preamble on the selected subchannel.

Some aspects described herein relate to a non-transitory computer-readable medium that stores a set of instructions for wireless communication by a reader device. The set of instructions, when executed by one or more processors of the reader device, may cause the reader device to sense a channel. The set of instructions, when executed by one or more processors of the reader device, may cause the reader device to measure interference on one or more subchannels of the channel. The set of instructions, when executed by one or more processors of the reader device, may cause the reader device to select a subchannel, of the one or more subchannels, that satisfies an interference threshold. The set of instructions, when executed by one or more processors of the reader device, may cause the reader device to transmit a clock synchronization signal or a preamble on the selected subchannel.

Some aspects described herein relate to a non-transitory computer-readable medium that stores a set of instructions for wireless communication by a wireless device. The set of instructions, when executed by one or more processors of the wireless device, may cause the wireless device to select a subchannel, of a channel associated with a reader device, that corresponds to a quantity of clock cycles. The set of instructions, when executed by one or more processors of the wireless device, may cause the wireless device to receive a clock synchronization signal or a preamble on the selected subchannel.

Some aspects described herein relate to an apparatus for wireless communication. The apparatus may include means for sensing a channel. The apparatus may include means for measuring interference on one or more subchannels of the channel. The apparatus may include means for selecting a subchannel, of the one or more subchannels, that satisfies an interference threshold. The apparatus may include means for transmitting a clock synchronization signal or a preamble on the selected subchannel.

Some aspects described herein relate to an apparatus for wireless communication. The apparatus may include means for selecting a subchannel, of a channel associated with a reader device, that corresponds to a quantity of clock cycles. The apparatus may include means for receiving a clock synchronization signal or a preamble on the selected subchannel.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment of a system of Internet-of-Things (IoT) devices.

FIG. 2 is a diagram illustrating example components of a device.

FIG. 3 is a diagram illustrating an aspect of energy harvesting.

FIG. 4 is a diagram illustrating an aspect of backscatter communication.

FIG. 5 is a diagram illustrating an example associated with clock synchronization of IoT devices.

FIG. 6 is a flowchart of an example process associated with sensing-based clock synchronization.

FIG. 7 is a flowchart of an example process associated with sensing-based clock synchronization.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Radio-frequency identification (RFID) and Bluetooth Low Energy (BLE) devices need to be synchronized in time to effectively ensure accurate data transmission. Passive RFID tags, which are widely used due to their low cost and simple inventory methods, have limitations in range and data throughput. These tags offer short-range communication and rely on real-time radio frequency (RF) energy to operate within the designated frequency band. This confines the applicability and usefulness of the devices in environments requiring broader coverage or heavier sensing data.

The design of energy-harvesting BLE (EH-BLE) systems necessitates low-cost implementations to ensure widespread adoption and cost-effectiveness. One of the challenges in designing low-cost EH-BLE tags is the need for these tags to operate without a battery and, more importantly, without a crystal for clock accuracy. The absence of a crystal leads to a lower clock accuracy, which in turn cannot meet Bluetooth specifications unless compensated by some form of online synchronization. This online synchronization typically involves sending a synchronization signal over the air for the tag to calibrate its transmission clock, which is highly sensitive to interference.

Furthermore, the synchronization process expects the EH-BLE tag to rely on wireless power transfer for charging and over-the-air signals for frequency tuning, given its lack of an internal power source. This reliance on external signals makes the process of clock synchronization even more prone to interference, as the signal used for synchronization must be robust enough to overcome any competing signals in the environment.

The choice of subband or subchannel for transmitting the synchronization signal to the EH-BLE tag can therefore significantly impact the susceptibility of the signal to interference. A suboptimal choice can lead to errors in the tag's clock calibration, resulting in inaccurate synchronization and potentially compromised data transmission. If the frequency of the clock synchronization signal is not fixed, additional challenges arise. The EH-BLE tag may not effectively utilize the signal for clock calibration due to variations in the number of RF cycles, which depends on the transmission frequency of the synchronization signal. If the device does not select a less-interfered transmission frequency for synchronization, the synchronization may be inaccurate or fail, which can lead to degraded communications. As a result, power, signaling resources, and processing resources are wasted.

Various aspects relate generally to enhancing synchronization processes within wireless communication systems, particularly in environments employing EH-BLE tags. Some aspects more specifically relate to a method where a reader device senses channel interference and selects an optimal subchannel for transmitting a clock synchronization signal or preamble, thus ensuring minimal interference impact on the EH-BLE tags during synchronization.

In some aspects, the reader device may transmit an indication of the frequency of the selected subchannel via control information. The indication could be transmitted before the clock synchronization signal or included within the preamble, enabling EH-BLE tags to accurately identify the subchannel used for clock synchronization. The selection of the subchannel may follow a round-robin measurement approach among possible subchannels, picking the first subchannel that meets an established interference threshold. In some aspects, rather than use an explicit indication of the subchannel, the tag may select the subchannel for frequency determination based on a hypothesis and criteria.

Particular aspects of the subject matter described in this disclosure can be implemented to realize one or more of the following potential technical advantages. By employing channel sensing and interference measurement, the described techniques can be used to dynamically select the subchannel with the least interference for clock synchronization signals, enhancing the synchronization accuracy and reducing the likelihood of synchronization failures. This approach minimizes the likelihood of data transmission errors and conserves power, signaling resources, and processing resources by reducing the need for retransmissions due to synchronization issues.

In addition, the inclusion of control information indicating the frequency of the selected subchannel allows EH-BLE tags to compensate for local clock inaccuracies and align their clocks with the reader device more precisely. As a result, this may conserve processing resources, as the EH-BLE tags can adjust their clocks with fewer computational cycles due to the provision of explicit synchronization information.

Furthermore, by transmitting a look-up table (LUT) indicating which subchannels correspond to specific quantities of clock cycles, the EH-BLE tags can use this LUT reference to efficiently adjust their internal clocks based on the subchannel frequency. This adaptive approach enables tags to judiciously manage their processing resources by providing a direct method for clock adjustment without extensive calculations.

Overall, the solutions provided by the claims improve the technical performance of EH-BLE systems by ensuring robust synchronization for maintaining the integrity and throughput of data communications within BLE networks. The solutions facilitate the broader adoption of EH-BLE systems in various applications, such as inventory management, asset tracking, and ambient Internet-of-Things (A-IoT) deployments, which offer advantages over passive RFID technology in terms of range and sensing capabilities, while also conserving energy and processing resources.

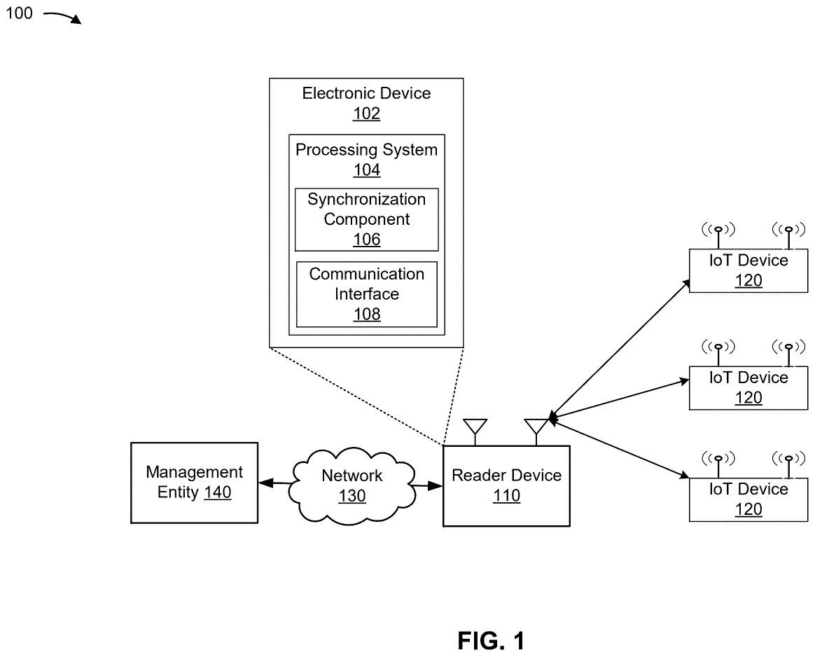

FIG. 1 is a diagram illustrating an example environment 100 of a system of IoT devices. The system of IoTs in FIG. 1 may include IoT devices 120 (e.g., A-IoT device, electronic shelf label (ESL) devices, RFIDs for commercial or residential inventory) that can be inventoried by a reader device 110 (e.g., access point (AP)). The reader device 110 may assist in the management and control of the entire system and all of the interconnected devices. The reader device 110 and other devices may be configured to communicate with network entities via a network 130 that is wire-based or wireless, and may include a backhaul.

The IoT devices may include A-IoT devices that obtain energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, ambient IoT devices, RFID tags wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. For example, an RF receiver (e.g., an IoT device 120) may receive signals (e.g., radio signals carried on radio waves) from an RF transmitter (e.g., a reader device 110) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

A-IoT devices may rely on passive communication technologies, such as backscatter communication. Backscatter communication involves using an RF signal to write or transmit data without a battery or a power source. A transmitter/reader may be an RF source that transmits a continuous wave (CW) signal. The A-IoT device may harvest energy (e.g., tens or hundreds of microwatts of electricity) from the signal and use passive reflection and modulation of the signal to transmit a backscatter signal using the harvested energy. That is, the A-IoT device may modulate the signal to encode data and then reflect a fraction of the wave to the reader device or to the transmitter/reader. The backscatter signal may be encoded with information bits (e.g., identifying information, sensor information). The reader device 110 may receive the backscatter signal and read the information bits. In some scenarios, there may be multiple readers that provide continuous coverage to a location, such as a whole store/warehouse.

A-IoT devices may be categorized according to A-IoT device types. In some aspects, an A-IoT device of type A may have no energy storage and no independent signal generation (i.e., backscattering transmission). An A-IoT device of type A may have no passive filtering capability, and thus a transmitting device may not transmit a signal to difference devices at the same time but with different frequencies. An A-IoT device of type B may have energy storage but no independent signal generation (i.e., backscattering transmission). An A-IoT device of type A or an A-IoT device of type B may have no energy to maintain a clock (e.g., preconfiguring the monitoring occasion for a downlink signal may not work). The use of stored energy may include amplification for reflected signals. An A-IoT device of type C may have energy storage and independent signal generation (i.e., active RF component for transmission). An A-IoT device of type B or type C may have energy to maintain the clock, but the clock stability may be loose.

In some aspects, A-IoT devices or A-IoT device types may be placed into groups. Groups (grouping 1) may include a group for indoor devices, a group for outdoor devices, and a group for both indoor/outdoor devices. Other groups (grouping B) may include a group of inventory devices, a group of sensors, a group of positioning devices, or a group of command devices. Grouping A and grouping B may be separate or together (e.g., group first by A, and second by B).

The reader device 110 and IoT devices 120 may use transceiver circuitry that includes at least one transmitter and at least one receiver. The coupling shown for the system (e.g. between an IoT device 120 and the reader device 110) is wireless and bidirectional. However, other coupling methods such as hard wiring (or a hybrid combination of the two coupling methods or mechanisms working together) can be used, without deviating from the devices, methods, spirit, and scope disclosed herein. A management entity 140 (e.g., central control unit) may provide control and processing, as well as other functionality used to support and implement the system. The management entity 140 may also implement a supervisory or master role within the communication network.

Each of the reader device 110, an IoT device 120, and the management entity 140 may be an electronic device 102. The electronic device 102 includes one or more devices capable of establishing a secure connection. For example, the electronic device 102 may include a wired and/or wireless communication and/or computing device, such as an access point, a station, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The reader device 110 may include one or more devices (e.g., electronic device 102) capable of receiving, processing, storing, routing, and/or providing traffic (e.g., a packet and/or other information or metadata) in a manner described herein. For example, the reader device 110 may include or may be coupled to a router, such as a label switching router (LSR), a label edge router (LER), an ingress router, an egress router, a provider router (e.g., a provider edge router or a provider core router), a virtual router, or another type of router. Additionally, or alternatively, the reader device 110 may include or may be coupled to a gateway, a switch, a firewall, a hub, a bridge, a reverse proxy, a server (e.g., a proxy server, a cloud server, or a data center server), a load balancer, and/or a similar device. Additionally, or alternatively, other network nodes may connect with the reader device 110 or the IoT devices 120. A network node may include a base station (a Node B, an eNB, and/or a gNB, among other examples), a relay device, a network controller, a transmit receive point (TRP), an apparatus, a device, a computing system, one or more components of any of these, and/or another processing entity configured to perform one or more aspects of the techniques described herein. For example, the network node may be an aggregated base station and/or one or more components of a disaggregated base station (e.g., a central unit (CU), a distributed unit (DU), and/or a radio unit (RU), also known as a remote radio unit (RRU) or remote radio head (RRH)). The reader device 110 may operate as a network node. In some aspects, the reader device 110 may be a physical device implemented within a housing, such as a chassis. In some aspects, the reader device 110 may be a virtual device implemented by one or more computing devices of a cloud computing environment or a data center. In some aspects, a group of network nodes may be a group of data center nodes that are used to route traffic flow through a network.

The management entity 140 may include one or more devices (e.g., electronic device 102) capable of providing services related to a user state and/or a user intent associated with the electronic device. For example, the management entity 140 may include a wired and/or wireless communication and/or computing device, such as a UE, wireless or mobile station, a mobile phone (e. g., a smart phone, a radiotelephone, and/or the like), a laptop computer, a tablet computer, a handheld computer, a desktop computer, a gaming device, a wearable communication device (e.g., a smart wristwatch or a pair of smart eyeglasses), or the like. Additionally, or alternatively, the management entity 140 may include a server, such as an application server, a client server, a web server, a database server, a host server, a proxy server, a virtual server (e.g., executing on computing hardware), or a server in a cloud computing system. In some aspects, the management entity 140 may include computing hardware used in a cloud computing environment.

The network 130 includes one or more wired and/or wireless networks. For example, the network 130 may include a cellular network (e.g., a code division multiple access (CDMA) network, a 3G network, a 4G network, a 5G network, a 6G network, or another type of next generation network, or the like), a public land mobile network (PLMN), a local area network (LAN) or a wireless LAN (WLAN), a wide area network (WAN) or a wireless WAN (WWAN), a personal area network (PAN) or a wireless PAN (WPAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

As shown, the electronic device 102 may include a processing system 104. The processing system 104 may include one or more components (or subcomponents), such as a synchronization component 106, a communication interface 108, and/or one or more other components described herein. For example, a component of the processing system 104 may be, be similar to, include, or be included in at least one memory, at least one communication interface, or at least one processor. The processing system 104 may generally correspond to a system that includes one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, as shown in FIG. 1, the processing system 104 may include the synchronization component 106, which may be configured to perform one or more tasks or operations described herein. In some aspects, the synchronization component 106 may direct the communication interface 108 to perform one or more communication tasks as described herein. Although depicted with reference only to the electronic device 102, any one or more of the IoT devices 120 and/or the management entity 140 may include a communication interface.

As used herein, the communication interface 108 may be any suitable interface that enables communication (e.g., wireless communication, wired communication, or a combination thereof) between the electronic device 102 and another entity or device, such as the IoT devices 120. The communication interface 108 may include electronic circuitry that enables the electronic device 102 to transmit, receive, or otherwise perform the communication. For example, the communication interface 108 may include a transmission component, a reception component, and/or a transceiver configured to communicate with other devices, such as via a wired connection, a wireless connection, or a combination of wired and wireless connections. In some examples, the communication interface 108 may include one or more RF components, an RF front end, one or more antennas, one or more transmit or receive processors, a demodulation component, and/or a modulation component, among other examples. In some examples, the communication interface 108 may include an Ethernet interface, an optical interface, a coaxial interface, an infrared interface, an RF interface, a universal serial bus (USB) interface, a Wi-Fi interface, a cellular network interface, a wireless modem, a short-range wireless interface, a Bluetooth interface, an inter-integrated circuit (I2C), and/or a serial peripheral interface (SPI), among other examples.

As described in more detail elsewhere herein, the electronic device 102 may be a first wireless device, such as reader device 110, and may (e.g., using the processing system 104 may, or the processing system 104) cause the synchronization component 106 and/or the communication interface 108 to sense a channel and measure interference on one or more subchannels of the channel. The first wireless device may select a subchannel, of the one or more subchannels, that satisfies an interference threshold, and transmit a clock synchronization signal or a preamble on the selected subchannel. Additionally, or alternatively, the electronic device 102 and/or the synchronization component 106 may perform one or more other operations described herein.

In some aspects, the electronic device 102 may be a second wireless device, such as an IoT device, may select a subchannel, of a channel associated with a reader device, that corresponds to a quantity of clock cycles, and receive a clock synchronization signal or a preamble on the selected subchannel. Additionally, or alternatively, the electronic device 102 and/or the synchronization component 106 may perform one or more other operations described herein.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment may perform one or more functions described as being performed by another set of devices of the environment.

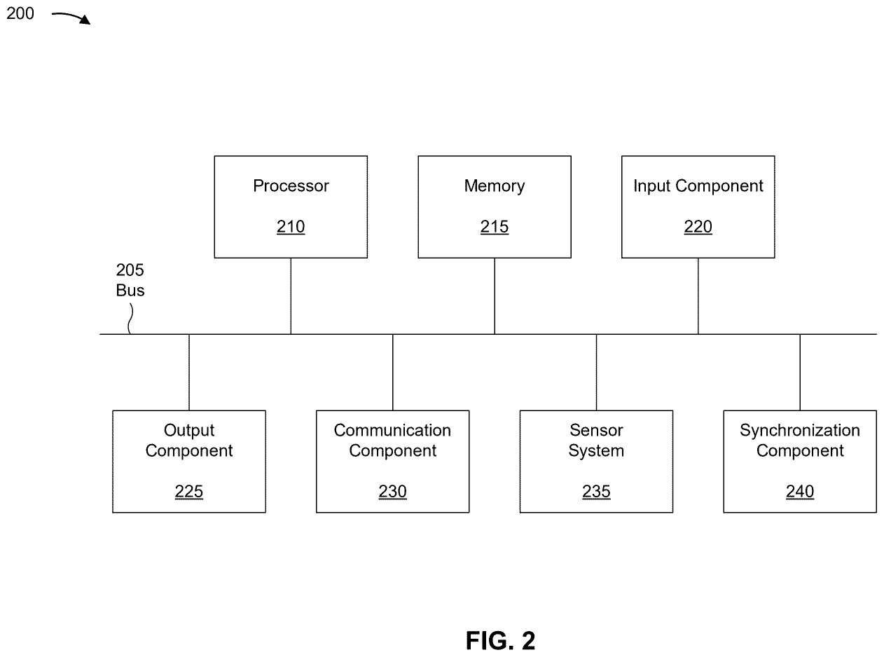

FIG. 2 is a diagram illustrating example components of a device 200. The device 200 may correspond to an electronic device 102, such as the reader device 110, an IoT device 120, and/or the management entity 140. In some aspects, the electronic device 102, the reader device 110, and/or the management entity 140 may include one or more devices 200 and/or one or more components of the device 200. As shown in FIG. 2, the device 200 may include a bus 205, a processor 210, a memory 215, an input component 220, an output component 225, a communication component 230, a sensor system 235, and/or a synchronization component 240.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The sensor system 235 includes one or more wired or wireless devices capable of receiving, generating, storing, transmitting, processing, detecting, and/or providing information associated with a state of the device 200 and/or an environment surrounding the device 200, as described elsewhere herein. For example, the sensor system 235 may include a motion sensor, an accelerometer, a gyroscope, an inertial measurement unit (IMU), a proximity sensor, a light sensor, a noise sensor, a pressure sensor, an ultrasonic sensor, a positioning sensor, a capacitive sensor, a timing device, an infrared sensor, an active sensor (e.g., a sensor that uses external power), a passive sensor (e.g., a sensor that does not need external power), a biological or biometric sensor, a smoke sensor, a gas sensor, a chemical sensor, an alcohol sensor, a temperature sensor, a moisture sensor, a humidity sensor, a radioactive sensor, a magnetometer, a hall sensor, an electromagnetic sensor, an analog sensor, and/or a digital or virtual sensor (e.g., a software-based sensor, or algorithm, that gathers data from one or more physical hardware sensors and generates an intended sensor output), among other examples. The sensor system 235 may sense or detect a condition or information related to a state of the device 200 and/or an environment surrounding the device 200 and transmit, using a wired or wireless communication interface, an indication of the detected condition or information to other components of the device 200 and/or other devices.

The synchronization component 240 includes one or more devices capable of receiving, generating, storing, transmitting, processing, detecting, and/or providing security keys and related commands, as described elsewhere herein. For example, in some aspects, the synchronization component 240 may provide, from a host of a first wireless device (e.g., device 200) to a controller of the first wireless device, a generate key command that includes one or more coordinates for encryption and a connection handle associated with a connection between the first wireless device and a second wireless device (e.g., device 200) that operates with a low energy wireless protocol; generate, at the controller, a security key based at least in part on the one or more coordinates and the connection handle; provide the security key from the controller to the host; and transmit, from the controller, a check value for the security key to the second wireless device in association with establishing the connection. Additionally, or alternatively, the synchronization component 240 may perform other operations described herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may be a first wireless device, such a reader device. The reader device includes means for sensing a channel; means for measuring interference on one or more subchannels of the channel; means for selecting a subchannel, of the one or more subchannels, that satisfies an interference threshold; or means for transmitting a clock synchronization signal or a preamble on the selected subchannel. In some aspects, the means for the reader device to perform operations described herein may include one or more of processor 210, memory 215, communication component 230, and synchronization component 240.

In some aspects, a wireless device (e.g., IoT device) may include means for selecting a subchannel, of a channel associated with a reader device, that corresponds to a quantity of clock cycles; and means for receiving a clock synchronization signal or a preamble on the selected subchannel. In some aspects, the means for the wireless device to perform operations described herein may include one or more of processor 210, memory 215, communication component 230, and synchronization component 240.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

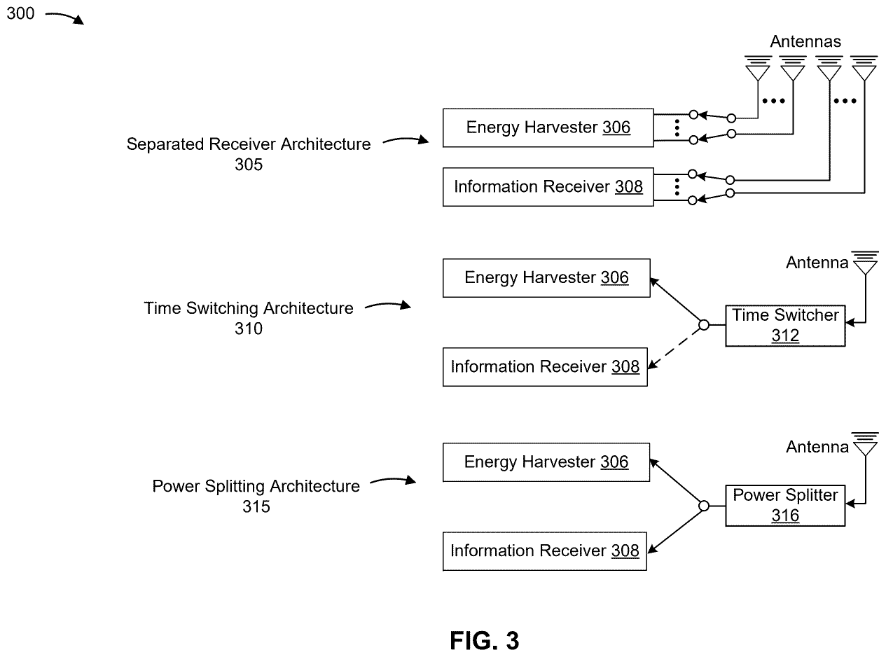

FIG. 3 is a diagram illustrating an aspect 300 of energy harvesting. Energy harvesting includes a device obtaining energy from a source other than an on-device battery. This may include obtaining energy from a source outside of the device. Devices that use energy harvesting may have a small energy storage device or battery (e.g., smart watch) or no energy storage device or battery (e.g., zero-power devices, IoT devices, wearables, or financial devices). Such devices may be categorized based on energy storage capacities. Some devices may have no energy storage (storage capacity 1). Some devices may store up to E1 Joules (storage capacity 2). Some devices may store up to E2 Joules (storage capacity 3).

Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 3, an RF receiver (e.g., electronic device 102) may receive signals (e.g., radio signals carried on radio waves) from an RF transmitter (e.g., electronic device 102) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 305, in some aspects, the RF receiver may use a separated receiver architecture, where a first set of antennas is configured to harvest energy (e.g., using energy harvester 306), and a second set of antennas is configured to receive data (e.g., using information receiver 308). In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 310, in some aspects, the RF receiver may use a time-switching architecture (e.g., with time switcher 312) to harvest energy. The time switching architecture may use one or more antennas to receive signals, and whether the signals are harvested for energy or processed to receive information depends on the time at which the signals are received. In some aspects, one or more first time slots may be time slots during which received signals are sent to one or more energy harvesting components, such as energy harvester 306, to harvest energy, and one or more second time slots may be time slots during which received signals are processed and decoded by one or more information receivers 308 to receive information. In some aspects, the time slots may be pre-configured (e.g., by the RF receiver, the RF transmitter, or another device).

As shown by reference number 315, in some aspects, the RF receiver may use a power splitting architecture (e.g., with power splitter 316) to harvest energy. The power splitting architecture may use one or more antennas to receive signals, and the signals are handled by one or both of the energy harvesting and/or information receiving components according to an energy harvesting rate. In some aspects, the RF receiver may be configured to use a first portion of received signals for energy harvesting and the remaining received signals for information receiving. The energy harvesting mode for a device may be semi-statistically configured by control messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. In some aspects, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal (WUS) but not perform other communications. The energy harvesting device may have a main radio that is configured to perform communications and that consumes more power than the low-power radio or wake-up radio. The energy harvesting device may have limited RF capabilities (less than enhanced) or full RF capabilities (comparable to enhanced mobile device).

Energy harvesting devices, more generally, may rely equally or differently on different energy harvesting techniques such as solar power, vibration, thermal energy, or RF energy harvesting. Energy harvesting can be predictable or unpredictable due to the energy being intermittently available. Current communications use fixed activity cycles for transmission and reception, such as an on duration of an active discontinuous reception (DRX) cycle.

As indicated above, FIG. 3 is provided as an aspect. Other aspects may differ from what is described with regard to FIG. 3.

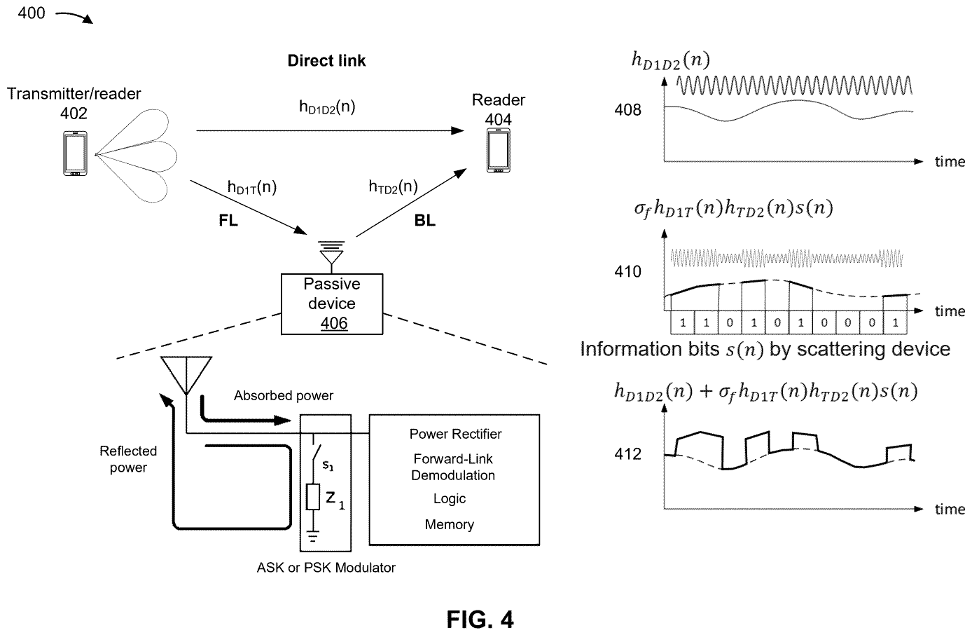

FIG. 4 is a diagram illustrating an aspect 400 of backscatter communication. Energy harvesting (EH) devices may include A-IoT devices (e.g., RFID tags) that rely on passive communication technologies, such as backscatter communication. An A-IoT may also be referred to as an “A-IoT,” “passive device,” “ambient backscatter device,” or “backscatter device.” An A-IoT device may include a passive device, a semi-passive device, or an active device. For transmission, an A-IoT device may include both backscatter communication and active transmission. Backscatter communication involves using an RF signal to write or transmit data without a battery or a power source. A transmitter/reader 402 may be an RF source that transmits a CW signal (radio wave denoted as x(n)) that may be received by multiple devices, such as a reader 404. A wireless device, such as passive device 406 (e.g., a tag, an A-IoT device, a passive device, a device without an energy source, a backscattering device) or a semi-passive device (e.g., some battery power), may harvest energy (e.g., tens or hundreds of microwatts of electricity) from the signal. The passive device 406 or the semi-passive device may use passive reflection and modulation of the signal to transmit a backscatter signal using the harvested energy. That is, the passive device 406 or the semi-passive device may modulate the signal to encode data and then reflect a fraction of the wave to the reader 404 or to the transmitter/reader 402. The backscatter signal may be encoded with information bits (e.g., identifying information, sensor information) of the passive device 406 or semi-passive device. The reader 404 may receive the backscatter signal and read the information bits. In some scenarios, the passive device 406 or the passive device may use information commands (e.g., write, transmit) or bits (e.g., data, configuration, indications) modulated in a received data or control signal to write commands or bits to the passive device 406 itself.

In aspect 400, D1 is for the transmitter/reader 402, D2 is for the reader 404, and T is for the passive device 406 for transmitted signal h. As shown by reference number 408, a CW signal may be represented by h_{D1D2}(n). One modulation method for backscattering includes amplitude shift keying (ASK), which switches on the reflection when transmitting information bit “1” and switches off the reflection when transmitting information bit “0”. Reference number 410 shows information bits by a backscattering device, represented as σ_{f}h_{D1T}(n)h_{TD2}(n)s(n). If the information bits of a backscattering device are s(n)∈{0,1}, the received signal at the reader 404 may be y(n)=(h_{D1D2}(n)+σ_{f}h_{D1T} (n)h_{TD2}(n)s(n))x(n)+noise, as shown by reference number 412. When s(n)=0, reflection is switched off at the passive device 406 such that the reader 404 only receives a direct link signal (y(n)=h_{D1D2}(n)x(n)+noise). When s(n)=1, reflection is switched on at the passive device 406 such that the reader 404 receives the superposition of both the direct link signal and the backscatter, which is represented as y(n)=(h_{D1D2}(n)+σ_{f}h_{D1T}(n)h_{TD2}(n)s(n))x(n)+noise, where σ_{f} denotes the reflection coefficient. The modulated wave from the passive device 406 may involve ASK or frequency-shift keying (FSK).

To receive the transmitted information bits by the passive device 406, the reader 404 may first decode x(n) based on the known h_{D1D2}(n), by treating the backscatter link signal as interference. The reader 404 may then detect the existence of the term σ_{f} h_{D1T}(n)h_{TD2}(n)s(n)x(n) by subtracting h_{D1D2}(n)x(n) from y(n).

There is a tradeoff between harvested energy at the passive device 406 and a received signal-to-noise ratio (SNR) at a reader (e.g., the reader 404). The harvested energy at the passive device 406 is a function of a first channel (forwarding link (FL)) between the transmitter/reader 402 and the passive device 406, and the SNR at the reader 404 is a function of both the first channel and a second channel (backscattering link (BL)) between the passive device 406 and the reader 404. Due to the difference between the first channel and the second channel and the energy harvester nonlinearity, the optimal transmit waveform design for SNR and the optimal transmit waveform design for energy maximization are different.

A topology may be monostatic, where the RF source and the reader are the same device. A topology may be bistatic, where the RF source and the reader are different devices, such as shown in aspect 400. While an RFID tag may have a simple structure and an envelope detector for a carrier wave from a reader, an A-IoT device may involve a topology that includes a network entity (e.g., gNB, an AP, and a tag (device as relay)) or a topology that includes a device and a tag. The A-IoT tag can be more powerful and may harvest and store energy.

Indoor use cases for sensors may include for smart homes, smart laundry, smart agriculture, smart farms, and smart stables. Outdoor use cases for sensors may include smart grids, forest fire monitoring, dairy farming, smart manholes, and smart bridge health monitoring. Commands for the devices may include commands for an online modification of medical instrument status, device activation and deactivation, elderly health care, permanent device deactivation, electronic shelf labels, or smart agriculture controllers.

A read command in an RFID may allow a receiving device (e.g., reader, interrogator) to read part or all of a tag's reserved memory, electronic product code (EPC) memory, tag ID (TID) memory, or user memory. The reserved memory may include the kill password and and/or access passwords. The EPC memory may include memory addresses or a code (such as an EPC, and hereafter referred to as an EPC) that identifies the object belonging to the tag and if the tag implements Extended Protocol Control (XPC). The TID memory may include identifying information for an interrogator to uniquely identify the custom commands and/or optional features that a tag supports. The user memory may allow user-specific data storage.

RFID and BLE devices need to be synchronized in time to effectively ensure accurate data transmission. Passive RFID tags, which are widely used due to their low cost and simple inventory methods, have limitations in range and data throughput. These tags offer short-range communication and rely on real-time RF energy to operate within the designated frequency band. This confines the applicability and usefulness of the devices in environments requiring broader coverage or heavier sensing data.

One of the challenges for low-cost EH-BLE tags is the need for these tags to operate without a battery and, more importantly, without a crystal for clock accuracy. The absence of a crystal leads to a lower clock accuracy, which in turn cannot meet Bluetooth specifications unless compensated by some form of online synchronization. This online synchronization typically involves sending a synchronization signal over the air for the tag to calibrate its transmission clock, which is highly sensitive to interference.

Furthermore, the synchronization process expects the EH-BLE tag to rely on wireless power transfer for charging and over-the-air signals for frequency tuning, given its lack of an internal power source. This reliance on external signals makes the process of clock synchronization even more prone to interference, as the signal used for synchronization must be robust enough to overcome any competing signals in the environment.

The choice of subband or subchannel for transmitting the synchronization signal to the EH-BLE tag can therefore significantly impact the susceptibility of the signal to interference. A suboptimal choice can lead to errors in the tag's clock calibration, resulting in inaccurate synchronization and potentially compromised data transmission. If the frequency of the clock synchronization signal is not fixed, additional challenges arise. The EH-BLE tag may not effectively utilize the signal for clock calibration due to variations in the number of RF cycles, which depends on the transmission frequency of the synchronization signal. If the device does not select a less-interfered transmission frequency for synchronization, the synchronization may be inaccurate or fail, which can lead to degraded communications. As a result, power, signaling resources, and processing resources are wasted.

As indicated above, FIG. 4 is provided as an aspect. Other aspects may differ from what is described with regard to FIG. 4.

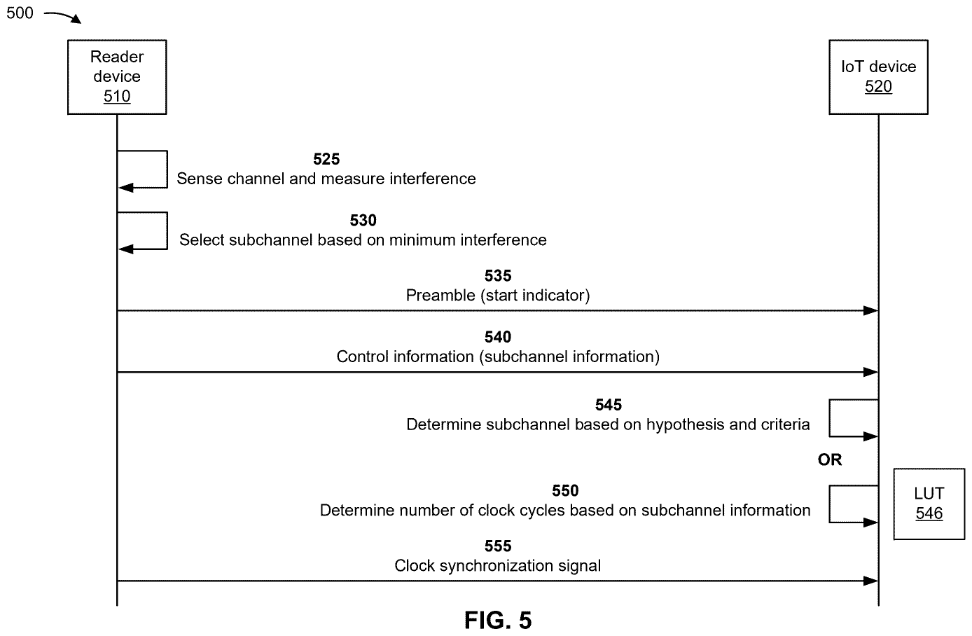

FIG. 5 is a diagram illustrating an example 500 associated with clock synchronization of IoT devices. As shown in FIG. 5, a reader device 510 (e.g., electronic device 102 or AP) and an IoT device 520 (e.g., electronic device 102, A-IoT device) may communicate with one another.

According to various aspects described herein, a reader device may sense channel interference and select an optimal subchannel for transmitting a clock synchronization signal or preamble, thus ensuring minimal interference impact on the EH-BLE tags during synchronization. In some aspects, the reader device may transmit an indication of the frequency of the selected subchannel via control information. The indication could be transmitted before the clock synchronization signal or included within the preamble, enabling EH-BLE tags to accurately identify the subchannel used for clock synchronization. In some aspects, rather than use an explicit indication of the subchannel, the tag may select the subchannel for frequency determination based on a hypothesis and criteria. By employing channel sensing and interference measurement, the described techniques can be used to dynamically select the subchannel with the least interference for clock synchronization signals, enhancing the synchronization accuracy and reducing the likelihood of synchronization failures. This approach minimizes the likelihood of data transmission errors and conserves power, signaling resources, and processing resources by reducing the need for retransmissions due to synchronization issues.

Example 500 shows sensing-based synchronization of IoT devices. The reader device 510 may sense a channel and measure interference on one or more subchannels of the channel, as indicated by operation 525. The number of cycles may be different based on the frequency of the subchannel. Channel sensing involves the process of monitoring a wireless communication channel to determine its current state, including the presence of other transmissions, noise levels, and overall channel conditions. This is typically done to ensure that the channel is clear and suitable for communication before initiating a transmission. The reader device 510 may listen to the channel for a predefined period. This involves tuning its receiver to the channel and monitoring the incoming signals. The main communication channel may be divided into multiple smaller subchannels. Each subchannel corresponds to a specific frequency range within the main channel. The reader device 510 may sequentially scan each subchannel to measure the level of interference.

After sensing the channel and measuring interference, the reader device 510 may select a subchannel, as shown by operation 530. The reader device 510 may select a subchannel that satisfies an interference threshold, ensuring that communication can be carried out with minimal interference. In some aspects, the reader device 510 may select the subchannel having the least amount of interference or a minimum amount of interference. The reader device 510 may measure interference on the subchannels using a round-robin scheme and select the first subchannel that satisfies the threshold (e.g., less than a maximum signal strength, greater than a minimum SNR). If no subchannel satisfies the threshold, the reader device 510 may adapt the threshold and/or back off from transmitting for a certain time duration.

As shown by operation 535, the reader device 510 may transmit a preamble. The preamble may include a start indicator to start synchronization. The reader device 510 may transmit the preamble in a selected subchannel.

In some aspects, the reader device 510 may transmit an explicit indication of the selected subchannel. As shown by operation 540, the reader device 510 may transmit control information. The control information may include subchannel information. The subchannel information may include an indication of the selected subchannel or a frequency of the selected subchannel. This facilitates synchronization between the reader device 510 and the IoT device 520 by allowing the IoT device 520 to identify the subchannel used for synchronization and subsequent communications. In some aspects, the control information may be carried with a part of the preamble.

Additionally, or alternatively, in some aspects, the IoT device 520 may determine and select the subchannel or the frequency of the subchannel based at least in part on a hypothesis that matches some defined criteria, as shown by operation 545. Different hypotheses may correspond to different reference numbers of clock cycle (clock cycle count) for different subchannels. There may be a frequency difference between the candidate subchannels that is large enough such that, even with the local clock errors of the IoT device 520, the IoT device 520 may still distinguish between different subchannels based on the number of clock cycles.

For example, the IoT device 520 may form a hypotheses about the possible subchannels that the reader device 510 may use for transmitting the clock synchronization signal. Each hypothesis corresponds to a different subchannel frequency. These hypotheses are based on predefined criteria, such as the expected number of clock cycles for each subchannel frequency. The IoT device 520 may use a LUT 546 that maps subchannel frequencies to the number of clock cycles. The criteria for testing these hypotheses may include matching the detected number of clock cycles with the expected number of clock cycles for each subchannel frequency. The IoT device may measure the number of clock cycles from a received signal and compare the number against the expected values in the LUT. The IoT device 520 may select the subchannel that best matches the hypothesis based at least in part on the criteria. This involves identifying the subchannel whose expected number of clock cycles closely aligns with the measured number of clock cycles.

By using the explicit indication or a hypothesis, the IoT device 520 can dynamically adapt to the subchannel with the least interference, ensuring robust synchronization and minimizing the likelihood of synchronization failures. This approach conserves power, signaling resources, and processing resources by reducing the need for retransmissions due to synchronization issues.

As shown by operation 550, the IoT device 520 may determine a reference number of clock cycles based at least in part on the frequency of the subchannel. The IoT device 520 may determine the frequency from a LUT 546 of subchannels and frequencies, which may be received from the reader device 510. The LUT 546 may also indicate subchannels/frequencies and corresponding number of clock cycles. By using the LUT 546, the IoT device 520 can accurately calculate the quantity of clock cycles for the selected subchannel.

The reader device 510 may transmit a clock synchronization signal on the selected subchannel, as shown by operation 555. This signal is used by the IoT device 520, with the reference number of clock cycles, to synchronize the internal clock of the IoT device 520 with the reader device 510, ensuring accurate timing in the communication.

For example, the IoT device 520 may use the reference number of clock cycles in conjunction with the synchronization signal to accurately align its internal clock with the clock of the reader device 510. Upon receiving the synchronization signal, the IoT device 520 may measure the actual number of clock cycles that occur during the synchronization period. The IoT device 520 may then compare the measured number of clock cycles with the reference number of clock cycles (e.g., obtained from the LUT 546). If there is a discrepancy between the measured number of clock cycles and the reference number, the IoT device 520 may adjust its internal clock to correct the difference. This adjustment ensures that the clock of the IoT device 520 is synchronized with the clock of the reader device 510. The adjustment process may involve speeding up or slowing down the internal clock of the IoT device 520 to match the reference number of clock cycles.

The IoT device 520 may continuously monitor and adjust its clock based on subsequent synchronization signals from the reader device 510. This ongoing process ensures that the IoT device remains synchronized with the reader device, which is essential for accurate data transmission and communication. As a result, power is not wasted on misaligned transmissions.

As indicated above, FIG. 5 is provided as an example. Other examples may differ from what is described with respect to FIG. 5.

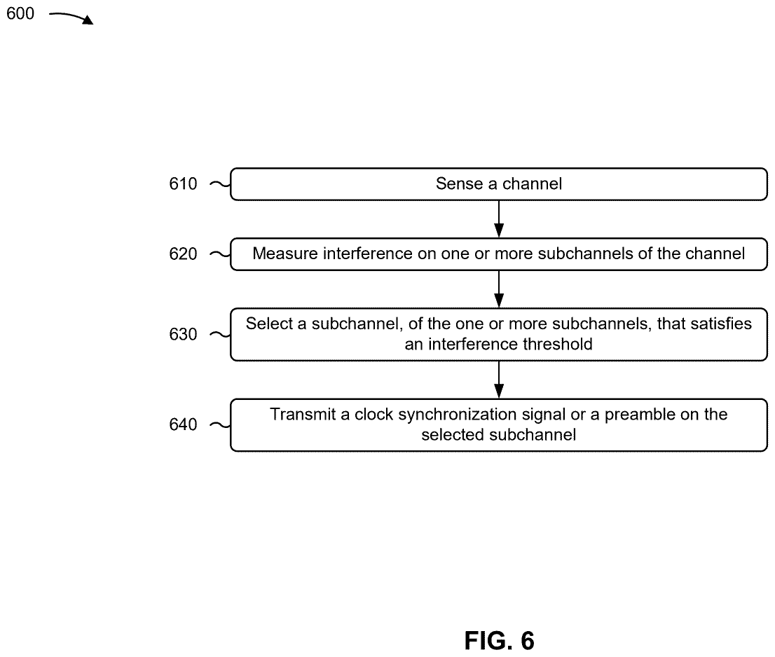

FIG. 6 is a flowchart of an example process 600 associated with sensing-based clock synchronization. In some aspects, one or more process blocks of FIG. 6 are performed by a reader device (e.g., reader device 510). In some aspects, one or more process blocks of FIG. 6 are performed by another device or a group of devices separate from or including the reader device. Additionally, or alternatively, one or more process blocks of FIG. 6 may be performed by one or more components of device 200, such as processor 210, memory 215, input component 220, output component 225, communication component 230, sensor system 235, and/or synchronization component 240.

As shown in FIG. 6, process 600 may include sensing a channel (block 610). For example, the reader device may sense a channel, as described above.

As further shown in FIG. 6, process 600 may include measuring interference on one or more subchannels of the channel (block 620). For example, the reader device may measure interference on one or more subchannels of the channel, as described above.

As further shown in FIG. 6, process 600 may include selecting a subchannel, of the one or more subchannels, that satisfies an interference threshold (block 630). For example, the reader device may select a subchannel, of the one or more subchannels, that satisfies an interference threshold, as described above.

As further shown in FIG. 6, process 600 may include transmitting a clock synchronization signal or a preamble on the selected subchannel (block 640). For example, the reader device may transmit a clock synchronization signal or a preamble on the selected subchannel, as described above.

Process 600 may include additional aspects, such as any single aspect or any combination of aspects described below and/or in connection with one or more other processes described elsewhere herein.

In a first aspect, process 600 includes transmitting an indication of a frequency of the selected subchannel via control information.

In a second aspect, alone or in combination with the first aspect, the control information precedes a clock synchronization signal.

In a third aspect, alone or in combination with one or more of the first and second aspects, the control information is included in a preamble.

In a fourth aspect, alone or in combination with one or more of the first through third aspects, selecting the subchannel includes selecting a first subchannel of the one or more subchannels that satisfies the interference threshold as part of a round robin of measurements of the one or more subchannels.

In a fifth aspect, alone or in combination with one or more of the first through fourth aspects, process 600 includes transmitting a look up table that indicates subchannels, of the one or more subchannels, that correspond to respective quantities of clock cycles.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

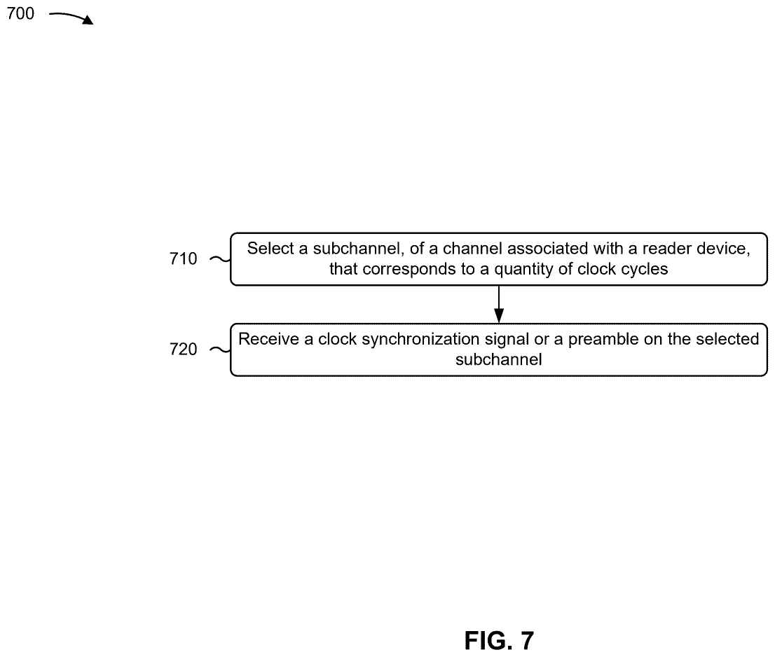

FIG. 7 is a flowchart of an example process 700 associated with sensing-based clock synchronization. In some aspects, one or more process blocks of FIG. 7 are performed by a wireless device (e.g., IoT device 520). In some aspects, one or more process blocks of FIG. 7 are performed by another device or a group of devices separate from or including the wireless device. Additionally, or alternatively, one or more process blocks of FIG. 7 may be performed by one or more components of device 200, such as processor 210, memory 215, input component 220, output component 225, communication component 230, sensor system 235, and/or synchronization component 240.

As shown in FIG. 7, process 700 may include selecting a subchannel, of a channel associated with a reader device, that corresponds to a quantity of clock cycles (block 710). For example, the wireless device may select a subchannel, of a channel associated with a reader device, that corresponds to a quantity of clock cycles, as described above.

As further shown in FIG. 7, process 700 may include receiving a clock synchronization signal or a preamble on the selected subchannel (block 720). For example, the wireless device may receive a clock synchronization signal or a preamble on the selected subchannel, as described above.

Process 700 may include additional aspects, such as any single aspect or any combination of aspects described below and/or in connection with one or more other processes described elsewhere herein.

In a first aspect, process 700 includes receiving an indication of a frequency of the selected subchannel via control information.

In a second aspect, alone or in combination with the first aspect, the control information precedes a clock synchronization signal.

In a third aspect, alone or in combination with one or more of the first and second aspects, the control information is included in a preamble.

In a fourth aspect, alone or in combination with one or more of the first through third aspects, process 700 includes receiving an LUT that indicates subchannels that correspond to respective quantities of clock cycles, and using a quantity of clock cycles based at least in part on the LUT and the selected subchannel.

In a fifth aspect, alone or in combination with one or more of the first through fourth aspects, selecting the subchannel includes selecting the subchannel based at least in part on a hypothesis that matches detection criteria.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:
Aspect 1: A method of wireless communication performed by a reader device, comprising: sensing a channel; measuring interference on one or more subchannels of the channel; selecting a subchannel, of the one or more subchannels, that satisfies an interference threshold; and transmitting a clock synchronization signal or a preamble on the selected subchannel.
Aspect 2: The method of Aspect 1, further comprising transmitting an indication of a frequency of the selected subchannel via control information.
Aspect 3: The method of Aspect 2, wherein the control information precedes a clock synchronization signal.
Aspect 4: The method of Aspect 2, wherein the control information is included in a preamble.
Aspect 5: The method of any of Aspects 1-4, wherein selecting the subchannel includes selecting a first subchannel of the one or more subchannels that satisfies the interference threshold as part of a round robin of measurements of the one or more subchannels.
Aspect 6: The method of any of Aspects 1-5, further comprising transmitting a look up table that indicates subchannels, of the one or more subchannels, that correspond to respective quantities of clock cycles.
Aspect 7: A method of wireless communication performed by a wireless device, comprising: selecting a subchannel, of a channel associated with a reader device, that corresponds to a quantity of clock cycles; and receiving a clock synchronization signal or a preamble on the selected subchannel.
Aspect 8: The method of Aspect 7, further comprising receiving an indication of a frequency of the selected subchannel via control information.
Aspect 9: The method of Aspect 8, wherein the control information precedes a clock synchronization signal.
Aspect 10: The method of Aspect 8, wherein the control information is included in a preamble.
Aspect 11: The method of any of Aspects 7-10, further comprising: receiving a look up table (LUT) that indicates subchannels that correspond to respective quantities of clock cycles; and using a quantity of clock cycles based at least in part on the LUT and the selected subchannel.
Aspect 12: The method of any of Aspects 7-11, wherein selecting the subchannel includes selecting the subchannel based at least in part on a hypothesis that matches detection criteria.
Aspect 13: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.
Aspect 14: An apparatus for wireless communication at a device, the apparatus comprising one or more memories and one or more processors coupled to the one or more memories, the one or more processors configured to cause the device to perform the method of one or more of Aspects 1-12.
Aspect 15: An apparatus for wireless communication, the apparatus comprising at least one means for performing the method of one or more of Aspects 1-12.
Aspect 16: A non-transitory computer-readable medium storing code for wireless communication, the code comprising instructions executable by one or more processors to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.
Aspect 18: A device for wireless communication, the device comprising a processing system that includes one or more processors and one or more memories coupled with the one or more processors, the processing system configured to cause the device to perform the method of one or more of Aspects 1-12.
Aspect 19: An apparatus for wireless communication at a device, the apparatus comprising one or more memories and one or more processors coupled to the one or more memories, the one or more processors individually or collectively configured to cause the device to perform the method of one or more of Aspects 1-12.
Aspect 20: A device comprising a processing system that includes one or more processors and one or more code-storing memories coupled with the one or more processors, the processing system configured to cause the device to perform the method of one or more of Aspects 1-12.
Aspect 21: A device comprising a processing system that includes processor circuitry and code-storing memory circuitry, the processing system configured to cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A reader device, comprising:
a processing system that includes one or more processors and one or more code-storing memories coupled with the one or more processors, the processing system configured to cause the reader device to:
sense a channel;
measure interference on one or more subchannels of the channel;
select a subchannel, of the one or more subchannels, that satisfies an interference threshold; and
transmit a clock synchronization signal or a preamble on the selected subchannel.

2. The reader device of claim 1, wherein the processing system is configured to cause the reader device to transmit an indication of a frequency of the selected subchannel via control information.

3. The reader device of claim 2, wherein the control information precedes a clock synchronization signal.

4. The reader device of claim 2, wherein the control information is included in a preamble.

5. The reader device of claim 1, wherein the processing system, to cause the reader device to select the subchannel, is configured to cause the reader device to select a first subchannel of the one or more subchannels that satisfies the interference threshold as part of a round robin of measurements of the one or more subchannels.

6. The reader device of claim 1, wherein the processing system is configured to cause the reader device to transmit a look up table that indicates subchannels, of the one or more subchannels, that correspond to respective quantities of clock cycles.

7. A wireless device, comprising:
a processing system that includes one or more processors and one or more code-storing memories coupled with the one or more processors, the processing system configured to cause the wireless device to:
select a subchannel, of a channel associated with a reader device, that corresponds to a quantity of clock cycles; and
receive a clock synchronization signal or a preamble on the selected subchannel.

8. The wireless device of claim 7, wherein the processing system is configured to cause the wireless device to receive an indication of a frequency of the selected subchannel via control information.

9. The wireless device of claim 8, wherein the control information precedes a clock synchronization signal.

10. The wireless device of claim 8, wherein the control information is included in a preamble.

11. The wireless device of claim 7, wherein the processing system is configured to cause the wireless device to:
receive a look up table (LUT) that indicates subchannels that correspond to respective quantities of clock cycles; and
use a quantity of clock cycles based at least in part on the LUT and the selected subchannel.

12. The wireless device of claim 7, wherein the processing system, to cause the wireless device to select the subchannel, is configured to cause the wireless device to select the subchannel based at least in part on a hypothesis that matches detection criteria.

13. A method of wireless communication performed by a reader device, comprising:
sensing a channel;
measuring interference on one or more subchannels of the channel;
selecting a subchannel, of the one or more subchannels, that satisfies an interference threshold; and
transmitting a clock synchronization signal or a preamble on the selected subchannel.

14. The method of claim 13, further comprising transmitting an indication of a frequency of the selected subchannel via control information.

15. The method of claim 14, wherein the control information precedes a clock synchronization signal.

16. The method of claim 14, wherein the control information is included in a preamble.

17. The method of claim 13, wherein selecting the subchannel includes selecting a first subchannel of the one or more subchannels that satisfies the interference threshold as part of a round robin of measurements of the one or more subchannels.

18. The method of claim 13, further comprising transmitting a look up table that indicates subchannels, of the one or more subchannels, that correspond to respective quantities of clock cycles.
